(19) United States
(12) Patent Application Publication
(10) Pub. No.: US 2025/0216083 A1
(43) Pub. Date: Jul. 3, 2025

(54) Control element for a cooktop, coupling element, control device and cooktop

(71) Applicant: BSH Hausgeräte GmbH, Munich (DE)

(72) Inventors: Luis Alberto Abascal Carrera, Camargo (ES); Roberto Carballo Fernandez, Santander (Cantabria) (ES); Alvaro Martinez Diez, Peñacastillo (Santander) (ES)

(21) Appl. No.: 18/843,735

(22) PCT Filed: Mar. 20, 2023
(86) PCT No.: PCT/EP2023/056993

§ 371 Date: Sep. 4, 2024

(30) Foreign Application Priority Data
Mar. 21, 2022 (EP) 22382262

(51) Int. Cl. F24C 3/12; G05G 1/10

(52) U.S. Cl. CPC F24C 3/124; G05G 1/10

(57) ABSTRACT

A control element for a gas cooktop comprises a handling section, a base section for covering an opening in a plate, and a coupling section attached to the base section. The coupling section protrudes from the base section and includes at least one recess for receiving a corresponding protrusion and/or includes at least one protrusion for engaging with a corresponding recess. And the coupling section further comprises at least one magnetic element for generating a magnetic pull.

The present disclosure relates to a control element for a cooktop, as, for example, a gas cooktop, a coupling element, a control device and a cooktop. Control elements, such as control knobs, for regulating a power or other functions of a cooktop, are mostly coupled to a control shaft.

For example, in gas cooktops, a functional coupling between a control knob and a gas valve for setting the power of a gas burner often needs to extend through a top plate of the cooktop. Usually, the cooktop has a flat top plate on which control elements, such as rotational control knobs, are arranged for the user. Often, an opening is provided in the top plate such that a control shaft reaches through the opening in the top plate. A control knob is then fixed to the shaft in order to allow a transmission of a control-knob rotation to the shaft.

Openings in top plates bear the risk of letting spilled liquids or particles enter through the opening into the interior of the household appliance. For example, such liquids may damage the valves or electronics within the appliance that is covered by the top plate. It is further desirable to have essentially flat surfaces in order to enhance the cleaning capabilities of a cooktop.

It is thus an object of the present disclosure to provide an improved control element for a cooktop, in particular for a gas cooktop, that allows for a reliable transmission of a movement of the control element onto a control shaft.

Accordingly, as a first aspect of this disclosure, a control element in particular for a gas cooktop is presented, the control element comprising:
a handling section;
a base section for covering at least part of an opening in a plate; and
a first coupling section attached to the base section, wherein the first coupling section protrudes from the base section and includes at least one recess for receiving a corresponding protrusion and/or includes at least one protrusion for engaging with a corresponding recess. The coupling section further comprises at least one magnetic element for generating a magnetic pull of the control element with respect to a control shaft, for example.

The magnetic element may provide for a proper position of the coupling section with respect to another coupling section or element.

It is understood that the magnetic element also includes a ferromagnetic element or magnetic pieces, as for example neodyme magnets. “Magnetic pull” shall include an attractive or repellent force depending on the orientation of the magnetic field with respect to another magnetic field or an ferromagnetic element.

For example, the handling section is suitable for being gripped and operated by a user of the cooktop. The base section, for example, covers an opening in a top plate of the cooktop, so that spills, such as liquids or particles, cannot enter the cooktop or appliance through the opening.

It is an advantage of the control element that its height can be reduced with respect to conventional control knobs. The combination of the mechanic coupling with the magnetic coupling allows for a reduction in the aspect ratio of the overall height, in particular a height above a corresponding top plate and its radial extension, as for example the diameter of the base section.

In embodiments, the magnetic elements are implemented to generate an asymmetric magnetic field with respect to a center axis of the control element.

The control element may include an axial extension and a radial extension. One may consider the axial extension colinear with a rotational axis of a handling section under use of the control element. Using an asymmetric magnetic field, magnetic forces can be created that put the control element into place with respect to a reference magnetic field, which is, for example, implemented in a fixed fashion at the gas cooktop. One may obtain a poka-yoke functionality in order to ensure the correct control element position with respect to a further coupling element.

In an embodiment of the control element, the coupling section comprises a receptacle or compartment for accommodating the at least one magnetic element. For example, the receptacle can have a lateral opening into which a magnetic piece or element can be inserted. Preferably, a receptacle receives the magnetic elements or a plurality of magnetic elements in a fixed fashion.

In embodiments, the recess is an elongated recess, as, for example, a gap, a slit or a notch. In embodiments, the protrusion is an elongated protrusion, in a particular an index, a rib, a fin or a ridge.

The recess or protrusion are in particular implemented to realize a form fit with a correspondingly shaped protrusion or recess in another element, as for example a second coupling element. An elongated recess or protrusion has, for example, an extension that is orientated radially with respect to an axis of the control element. One can also contemplate of form-fit couplings includes recesses and/or protrusions that are point-like or pin-like and allow for a rotational transmission of a movement of the control element onto a corresponding coupling element.

In embodiments, the coupling section comprises at least two magnetic elements arranged next to each other in a plane perpendicular to an axis of the control element. The magnetic elements have an opposite polarity with respect to the axis of the control element.

One may create a magnetic-field landscape with alternating polarity so that the first coupling section generates a magnetic pull with respect to a reference-magnetic field landscape so that the control element falls into the correct orientation or place. The reference-magnetic field landscape is, for example, generated by appropriate magnets in or at a coupling element.

In embodiments, the base section and/or the first coupling section has/have a flat cylindric form. “Flat cylindric form” shall mean that the height of the cylinder is less than the radial extension of the respective cylinder, i.e., its diameter.

In embodiments, the base section and the handling section have a combined height along an axis of the control element and a radial extension. The radial extension is preferably at least three times the combined height. Even more preferably, the radial extension is at least four times the combined height.

It is desirable to obtain a flat control element in order to improve the cleaning properties of a cooktop that is equipped with the presented control element.

According to another aspect of this disclosure, a coupling element for a control element, in particular according to the above or below explained embodiments, comprises a second coupling section adapted to mechanically couple a control shaft, wherein the second coupling section further comprises:
at least one protrusion for engaging with a corresponding recess and/or at least one recess for receiving a corresponding protrusion; and
at least one magnetic element for generating a magnetic pull.

The sleeve section is, in particular, adapted to be at least partially inserted into an opening of a top plate.

Hence, the sleeve may enclose the second coupling section, thus providing a relatively flat surface closing the opening in the top plate. Thus, spilled liquids or particles may not enter below the top plate. Further, cleaning of a cooktop involving a low height of the coupling element is enhanced or facilitated.

According to yet another aspect, a control device is presented, wherein the control device comprises a control element as disclosed above or below and a coupling element as disclosed above or below.

Preferably, the first coupling section and the second coupling section are magnetically coupled to one another. Further, the first and second coupling sections may be coupled through a form-fit so that a rotational movement of the first coupling element is transmitted to a rotational movement of the second coupling section.

The control device, for example, can be used in a gas cooktop allowing for an easy-to-clean gas cooktop and a reliable poka-yoke positioning of the control element, e.g., implemented as a rotational control knob.

In embodiments, a bottom side of the first coupling section faces to a top side of the second coupling section.

In embodiments, the control device comprises a plurality of magnetic elements in the first coupling section and a plurality of magnetic elements in the second coupling section. It is understood that magnetic elements may be magnets and/or ferromagnetic elements.

Preferably, the magnetic elements are positioned such that a magnetic force pushes the at least one recess into an engagement orientation with respect to the corresponding protrusion to enter a form-fit. Alternatively, or additionally, the magnetic force pushes the at least one protrusion in an engagement orientation with respect to the corresponding recess.

The plurality of magnetic elements form corresponding magnetic landscapes such that a proper positioning of the first and second coupling section with respect to one another is facilitated. The magnetic force is, in particular, a rotational force with respect to a rotational axis of the control device.

According to another aspect, a cooktop comprising a top plate with an opening and a coupling device as disclosed above or below is presented.

Preferably, the opening of the top plate is covered by the base section of the coupling element.

In embodiments, the opening can be closed by a combination of a sleeve section and a second coupling section. Thus, in embodiments, the top plate is arranged between the base section and the second coupling section.

According to this disclosure, a control element, such as a controller, can be used for a plurality of coupling elements, if a cooktop is used with a plurality of gas burners and corresponding gas valves. Thus, in an embodiment, the cooktop further comprises at least one gas valve having a valve shaft wherein the valve shaft is coupled to a second coupling section in a rotationally locked fashion.

In a further embodiment, the cooktop comprises a gas burner coupled to the gas valve.

Further possible implementations or alternative solutions of the invention also encompass combinations—that are not explicitly mentioned herein—of features described above or below with regard to the embodiments. The person skilled in the art may also add individual or isolated aspects and features to the most basic form of the invention.

Further embodiments, features and advantages of the present invention will become apparent from the subsequent description and dependent claims, taken in conjunction with the accompanying drawings, in which:

FIG. 1 shows a first perspective view of a first embodiment for a control element;

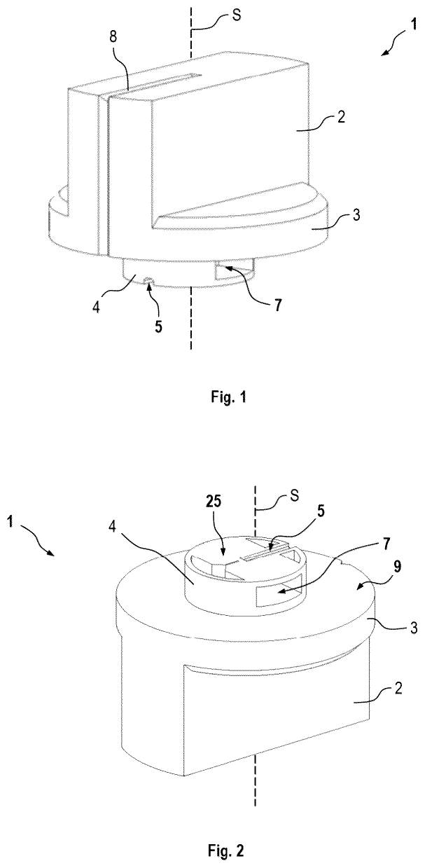

FIG. 2 shows a second perspective view of the first embodiment for a control element;

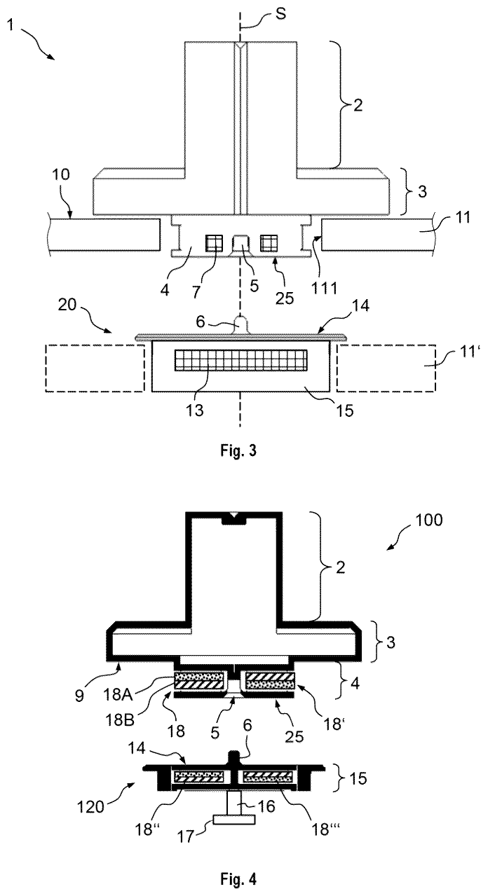

FIG. 3 shows a cross-sectional view of the first embodiment for a control element;

FIG. 4 shows a cross-sectional view of a second embodiment for a control element;

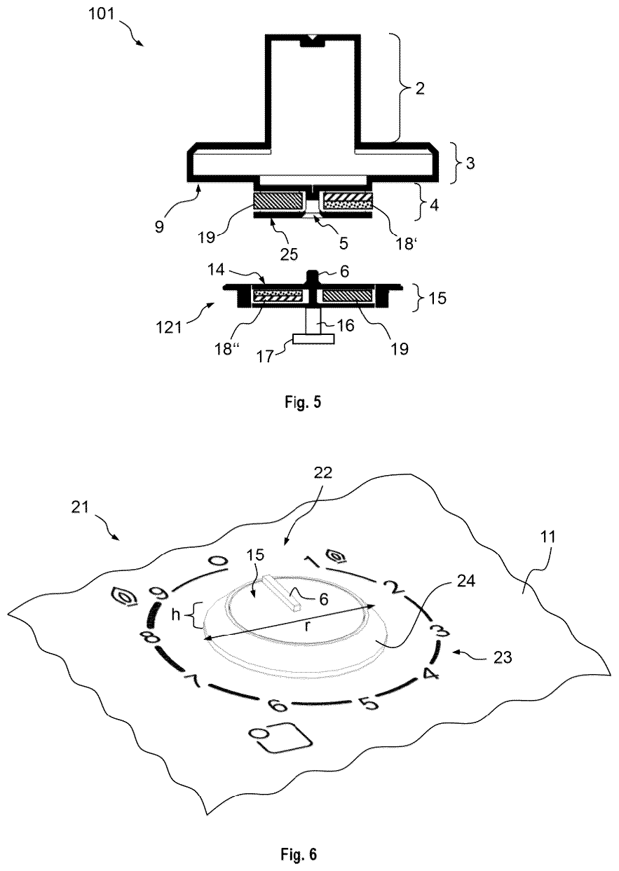

FIG. 5 shows a cross-sectional view of a third embodiment for a control element; and

FIG. 6 shows a perspective view of a cooktop with a fourth embodiment for a control element.

In the Figures, like reference numerals designate like or functionally equivalent elements, unless otherwise indicated.

FIGS. 1, 2 and 3 refer to a first embodiment of a control element wherein FIGS. 1 and 2 show perspective views and FIG. 4 a cross-sectional view. A control element 1 in terms of a rotational control knob is shown. The control knob 1 may be rotated along its axis S. For example, the control element or control knob 1 can be fixedly coupled to a valve shaft in order to set the gas flow through a corresponding gas valve and thus the power of a gas burner in a cooktop.

The control knob 1 is in particular formed of a plastic material and comprises in the orientation of FIG. 1 an upper handling section 2 that can be gripped by a user. The handling section 2 or grip 2 is attached to a cylindrical base plate 3, wherein the base plate or section 3 is a flat cylinder or disk. In the orientation of FIG. 1, a coupling section 4 protrudes downwardly from the base section 3.

FIG. 2 shows the control element 1 upside down with a view onto the lower side or bottom side 9 of the base section 3. The flat cylindrical coupling section 4 protrudes from the bottom side or surface 9 of the base section 3. In order to set the power, the handling section 2 in terms of a knob has an indicator 8 that may be directed to a value on a scale (not shown).

As shown in FIG. 2, the cylindrical coupling section 4 has a lateral opening 7 at its shell surface and a receptacle or compartment 7 for receiving magnetic elements. One can contemplate of several compartments or lateral openings 7 that are positioned on opposite sides of the circumferential wall of the coupling section 4 with respect to the axis S. The lower surface or bottom side 25 of the coupling section 4 has a radial groove implementing a coupling recess 5.

FIG. 3 shows in a cross-sectional view of a potential arrangement including the control knob 1 in combination with a top plate 11 of a cooktop and a corresponding coupling piece or coupling element 15. The top plate 11 has an opening 111 and a top surface or side 10. The top surface 10 is directed to a user of the corresponding cooktop, and below the top plate 11, further components of the household appliance are arranged. For example, if the cooktop is a gas cooktop, gas valves are arranged below the top plate 11 in the orientation of FIG. 3. The protruding first coupling section 4 of the control knob 1 reaches through the opening 111 so that its bottom side 25 faces downward.

A coupling piece or a coupling element 20 is shown in the lower part of FIG. 3. The coupling element 20 has an essentially cylindrical form with a top side 14 from which a rib or protrusion 6 protrudes upward. The shape of the protrusion 6 corresponds to the recess 5 in the coupling section 4 of the control knob 1. Both elements (protrusion 6 and recess 5) may realize a form fit for transmitting a rotational force from the second coupling element 20 to the first coupling element 4 and vice versa.

Further, magnetic elements 12, 13 are illustrated, wherein the first magnetic elements 12 are placed within the (first) coupling section 4 of the control knob 1 and second magnetic elements 13 are placed within the (second) coupling section 15 of the coupling element 20. The coupling element 20 is, for example, fixedly and in a rotationally locked fashion connected to a valve shaft. During assembly of the cooktop, the first coupling section 4 of the control knob 1 and the second coupling section 15 of the coupling element 20 are brought together along the axial direction S. In particular, the magnets 12, 13 generate a magnetic field such that the protrusion 6 and the recess 5 are positioned relative to each other in a correct fashion so that a form fit may occur. Thus, the ridge or index 6 enters into the corresponding groove 5.

The combination of a mechanical coupling and the magnetic coupling allows for a proper positioning and reliable transmission of a rotation of the control knob, e.g., through turning the handling section 2, to the coupling element 20.

FIG. 3 also shows an alternative arrangement with dotted lines. For example, the coupling element 20 may be inserted into an opening of the top plate 11′ of a cooktop (dashed illustration) so that a relatively flat surface is obtained. In an embodiment, a sleeve may enclose the coupling section 15 of the coupling element 20. In embodiments, the coupling elements have a rotational symmetry with respect to a rotational axis S.

FIGS. 4 and 5 show a second and third embodiment for a control element 100, 101 in combination with the coupling section 120, 121. The shape of the magnetic fields generated by the magnetic elements in the control element 100, 101 on the one hand and the coupling section 120, 121 on the other hand can be arranged such that magnetic forces automatically rotate the two elements with respect to another such that the form fit through the respective protrusion 6 and recess 5 slips into place. Further the magnets provide for an attractive force between the two elements.

FIG. 4 shows a control element 100 with a coupling element 120 in a cross-sectional view. The control element 120 comprises a cylindrical coupling section 15 as explained above which is fixedly coupled to a control shaft 16, for example of a gas valve 17. One can contemplate of other control shafts and other elements that need to be controlled by turning a shaft 16.

The coupling section 4 of the control knob element 100 includes, for example, two magnets 18, 18′. The polarity of the magnets 18, 18′ is indicated by the dashed and dotted regions 18A, 18B. For example, in the orientation of FIG. 4, the left-hand magnet 18 generates a magnetic field that points upwards. The right-hand magnet 18′, for example, generates a magnetic field with downward orientation.

FIG. 4 shows a situation where the orientation of the magnetic fields in the control knob 100 and the magnetic fields in the coupling section 15 of the coupling element 120 match with each other. That is, the magnetic field of magnet 18′ also points upwards, as the magnetic field of the magnet 18, and the magnetic field of magnet 18″ has the same orientation as the magnet 18′. Thus, there is a proper coupling between the control knob 100 and the coupling element or piece 120.

Hence, the magnetic-field landscape of the control knob 100 and the magnetic-field landscape of the coupling section 120 are arranged so that the control knob 100 falls into place with the protrusion 6 of the coupling section 15.

FIG. 5 shows a further embodiment of a control knob 101 in combination with the coupling element 121. FIG. 5 shows generally the same set-up as explained with respect to FIG. 4. However, instead of a combination of two corresponding magnets, a ferromagnetic element 19 is arranged in the receptacle of the first coupling section 4 and within the coupling section 15 of the coupling element 121. Further, two magnets 18′, 18″ are placed within the second receptacle of the coupling section 4 of the control knob 101 and in the cylindrical coupling section 15 of the coupling element 121, respectively.

For example, the magnetic field generated by the magnet 18′ points downward, while the polarity of the magnetic field generated by magnet 18″ points upwards. Thus, in an improper position of the control knob 101 with respect to the coupling section 121, the magnets 18′ and 18″ repel each other and rotate the control knob 101 such that each magnet 18′ and 18″ faces a ferromagnetic element 19 thereby pulling the two coupling sections 4, 15 axially together. Thus, the proper position of the control knob 101 can be ensured.

FIG. 6 shows a section of a cooktop, for example, equipped with control knobs or control devices as depicted above. The cooktop 21 is, for example, a gas cooktop with a top plate 11. In an opening (not shown) of the top plate 11, a coupling element 22 is inserted.

The coupling element 22 comprises a sleeve 24 placed partially within the opening. The coupling section 15 (as illustrated above with respect to the embodiments) is enclosed by the sleeve section 24. The coupling section 15 can be rotated within the sleeve 24. The combined height of the sleeve section 24 is denoted as h, wherein a radial extension in terms of a diameter is denoted by the arrow r.

The coupling section 15 comprises a protrusion 6 in terms of an index that may be coupled to a corresponding recess or groove in a control knob which is not shown. The top plate 11 carries a scale 23 indicating a set power for a gas burner.

One can appreciate from FIG. 6 that the overall height h is considerably smaller than the radial extension r. Thus, a relatively flat surface is obtained that can be easily cleaned even if liquids, pastes or particles are spilled onto the top plate 11.

The disclosed embodiments of control knobs and coupling devices in cooking appliances or cooktops improve cleaning the same and are easy to assemble. Due to a specific relationship between the magnetic landscapes of the coupling sections, a correct knob positioning in terms of a poka-yoke functionality is achieved. Further, using appropriate magnets the respective control element can be removably coupled to a coupling section fixed at a control shaft.

Although the present invention has been described in accordance with preferred embodiments, it is obvious for the person skilled in the art that modifications are possible in all embodiments. It is understood that the embodiments are only illustrative. For example, a plurality of magnetic elements can be distributed along a circumferential direction of the respective coupling sections.

### REFERENCE NUMERALS

1 control element
2 handling section
3 base section
4 coupling section
5 elongated recess
6 elongated protrusion
7 receptacle
8 indicator
9 bottom side
10 top side
11 top plate
111 opening
12, 13 magnetic element
14 top side
15 coupling section
16 shaft
17 control device
18, 18′ magnet piece
18″, 18″ magnet piece
18A, 18B magnetic pole
19 ferromagnetic piece
20 coupling element
21 cooktop
22 control knob
23 scale
24 apron/sleeve section
25 bottom side
100, 101 control element
120, 121 coupling element
S rotational axis
H height
r diameter

1-15. (canceled)

16. A control element for a cooktop, the control element comprising:
a handling section;
a base section designed to cover at least part of an opening in a plate; and
a coupling section attached to the base section and designed to protrude from the base section, the coupling section comprising a magnetic element for generating a magnetic pull and designed to include a recess for receiving a corresponding protrusion and/or to include a protrusion for engaging with a corresponding recess.

17. The control element of claim 16, wherein the magnetic element is designed to generate an asymmetric magnetic field with respect to a center axis of the control element.

18. The control element of claim 16, wherein the coupling section comprises a receptacle designed to accommodate the magnetic element.

19. The control element of claim 16, wherein the recess is an elongated recess, and wherein the protrusion is an elongated protrusion.

20. The control element of claim 19, wherein the elongated recess is a gap, a slit or a notch.

21. The control element of claim 19, wherein the elongated protrusion is an index, a rib, a fin or a ridge.

22. The control element of claim 16, wherein the coupling section comprises at least two of said magnetic element arranged next to each other in a plane perpendicular to an axis of the control element, the at least two of said magnetic element having an opposite polarity with respect to the axis of the control element.

23. The control element of claim 16, wherein at least one of the base section and the coupling section has a flat cylindric form.

24. The control element of claim 16, wherein the base section and the handling section have a combined height along an axis of the control element, and a radial extension, wherein the radial extension is at least three times the combined height.

25. A coupling element for a control element for a cooktop, the coupling element comprising a coupling section designed to mechanically couple a control shaft, the coupling section comprising:
a protrusion for engaging with a corresponding recess in the control element and/or a recess for receiving a corresponding protrusion of the control element; and
a magnetic element for generating a magnetic pull.

26. The coupling element of claim 25, further comprising a sleeve section designed to enclose the coupling section and being at least partially inserted into an opening of a top plate.

27. A control device for a cooktop, the control device comprising:
a control element comprising a handling section, a base section designed to cover at least part of an opening in a plate, a first coupling section attached to the base section and designed to protrude from the base section, the first coupling section comprising a magnetic element for generating a magnetic pull and designed to include a recess for receiving a corresponding protrusion and/or to include a protrusion for engaging with a corresponding recess; and
a coupling element comprising a second coupling section designed to mechanically couple a control shaft, the coupling section comprising a protrusion for engaging with a corresponding recess and/or a recess for receiving a corresponding protrusion, and a magnetic element for generating a magnetic pull,
wherein the first coupling section and the second coupling section are magnetically coupled to one another.

28. The control device of claim 27, wherein a bottom side of the first coupling section faces to a top side of the second coupling section.

29. The control device of claim 27, wherein the magnetic element in the first coupling section and the magnetic element in the second coupling section are positioned such that a magnetic force pushes the recess into an engagement orientation with respect to the corresponding protrusion and/or such that a magnetic force pushes the protrusion into an engagement orientation with respect to the corresponding recess.

30. A cooktop comprising:
a top plate having an opening; and
the control device set forth in claim 27,
wherein the opening is covered by the base section of the control element.

31. The cooktop of claim 30, wherein the top plate is arranged between the base section of the control element and the second coupling section of the coupling element.

32. The cooktop of claim 30, further comprising a gas valve including a valve shaft, the valve shaft being coupled to the second coupling section in a rotationally locked fashion.
